(19) United States
(12) Patent Application Publication
(10) Pub. No.: US 2009/0005148 A1
(43) Pub. Date: Jan. 1, 2009

(54) Method and Apparatus to Play a Roulette Game

(75) Inventor: Gerald Duhamel, Drummondville (CA)

Correspondence Address: LABTRONIX CONCEPT;C/O BENOIT & CO INC., 2025 LIMOGES, LONGUEUIL, QC, J4G 1C4, CA

(73) Assignee: Labtronix Concept Inc., Drummondville (CA)

(21) Appl. No.: 12/208,036

(22) Filed: Sep. 10, 2008

Related U.S. Application Data
(63) Continuation of application No. 11/060,715, filed on Feb. 18, 2005.
(60) Provisional application No. 60/570,462, filed on May 13, 2004.
(60) Provisional application No. 60/623,740, filed on Nov. 2, 2004.

(51) Int. Cl. A63F 13/00; A63F 5/00

(52) U.S. Cl. 463/17

(57) ABSTRACT

The present invention provides a method of playing a roulette game device played in response to a trigger in a primary game provided on at least two gaming machines communicatively linked to, but physically distinct from, said roulette game device. The method comprises: providing a player with a roulette game triggering event in said primary game played on said gaming machine; the player locking said gaming machine; said player accessing said roulette game device to play a roulette game; receiving a player selection of player indicia from said player on said roulette game device; activating said roulette game device; randomly determining roulette indicia on said roulette game device; comparing said player indicia to said roulette indicia to determine a roulette game outcome for said player; and upon entry of a wake up command by said player on said gaming machine, removing said primary game from said idle mode and allowing said player to play said primary game.

### CROSS-REFERENCE TO RELATED APPLICATIONS

This application is a continuation of patent application Ser. No. 11/060,715 filed on Feb. 18, 2005 which claims priority under 35USC § 119(e) of U.S. provisional patent application 60/542,279 filed Feb. 18, 2004, U.S. provisional patent application 60/570,462 filed May 13 2004, and U.S. provisional patent application 60/623,740 filed Nov. 2, 2004, the specifications of which are hereby incorporated by reference.

### TECHNICAL FIELD

The present invention relates to a roulette game apparatus communicatively linked to at least one game apparatus and the method to play a roulette game.

### BACKGROUND OF THE INVENTION

Gambling has evolved a lot during the last few years, and game manufacturers are always searching for new methods to interest and entertain players. Players are always demanding more features and payout schemes.

Improvements in these kinds of games are desired to enhance the player's interest and entertainment.

### SUMMARY OF THE INVENTION

In an embodiment, the present invention provides a method of playing a roulette game device played in response to a trigger in a primary game provided on at least two gaming machines communicatively linked to, but physically distinct from, said roulette game device. The method comprises: providing a player with a roulette game triggering event in said primary game played on said gaming machine; the player locking said gaming machine; said player accessing said roulette game device to play a roulette game; receiving a player selection of player indicia from said player on said roulette game device; activating said roulette game device; randomly determining roulette indicia on said roulette game device; comparing said player indicia to said roulette indicia to determine a roulette game outcome for said player; and upon entry of a wake up command by said player on said gaming machine, removing said primary game from said idle mode and allowing said player to play said primary game.

According to another embodiment, the game triggering event comprises a game access permission. According to other embodiments, the game access permission can be archived and the player can later select an archived game permission.

### BRIEF DESCRIPTION OF THE DRAWINGS

Further features and advantages of the present invention will become apparent from the following detailed description, taken in combination with the appended drawings, in which:

FIG. 1 is a schematic diagram showing a perspective view of a gaming machine suitable for the present invention;

FIG. 2 is a bloc diagram illustrating the components of the gaming machine of FIG. 1;

FIG. 3 is a schematic diagram showing a perspective view of a roulette device bearing player stations and suitable for the present invention;

FIG. 4 is a schematic diagram showing a perspective view of a roulette device connected to a plurality of player terminals and suitable for the present invention;

FIG. 5 is a flow chart of a game process in accordance with the present invention; and

FIG. 6 is a flow chart of a remote game process in accordance with the present invention.

It will be noted that throughout the appended drawings, like features are identified by like reference numerals.

### DETAILED DESCRIPTION OF THE PREFERRED EMBODIMENT

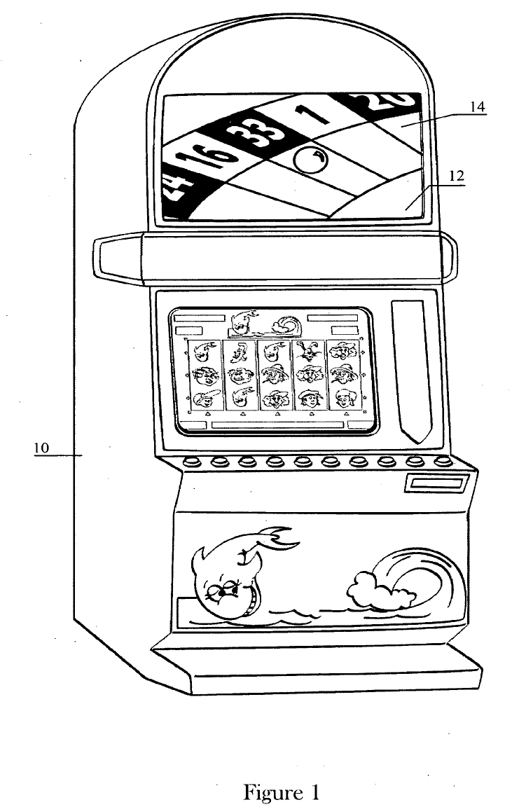

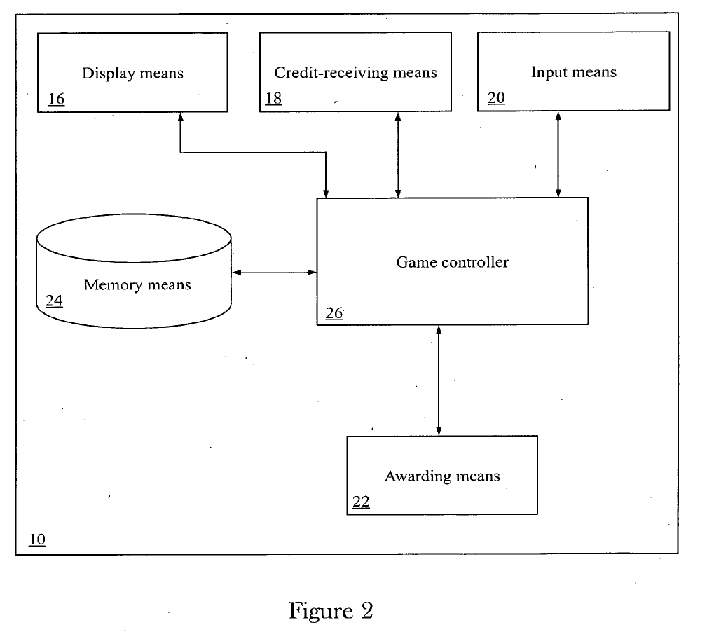

The present invention is preferably carried out in conjunction with a gaming machine, as illustrated in FIGS. 1 and 2. Said gaming machine 10 comprises display means 16, such as a video screen, a LCD screen or mechanical reels; credit-receiving means 18 such as a card reader, or a coin and/or bill acceptor; input means 20, such as buttons, levers or a touch screen; awarding means 22, such as a ticket printer, a card reader or a hopper; memory means 24 and a game controller means 26. Bonus display means (not shown) may also be added.

The invention may also be applied in conjunction with a computer program, or at a remote terminal, the game information (not shown) being distributed via a network, such as linked machines or the Internet, or broadcasted using an electrical or electromagnetic signal.

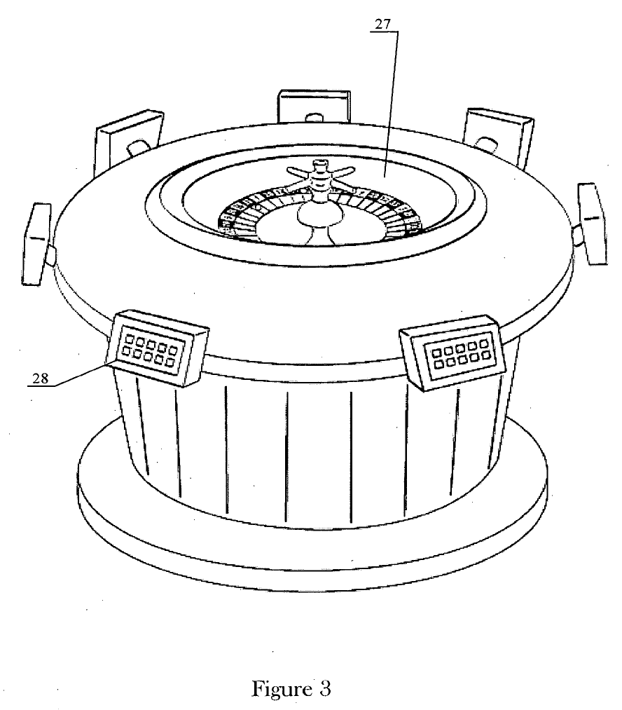

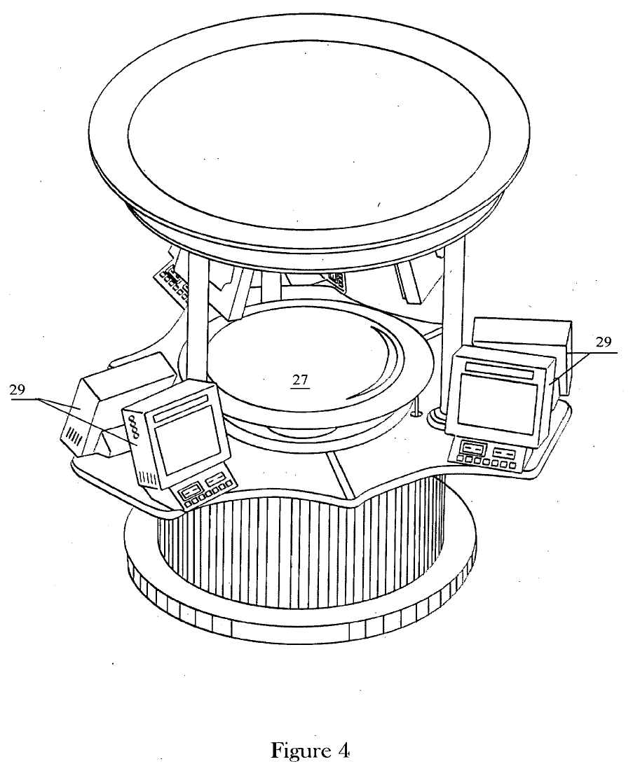

The bonus roulette apparatus may be a device added to the gaming machine, like a second screen (FIG. 1); a physical roulette device connected to at least one remote gaming machine (FIG. 3), bearing player stations or not; a physical roulette device connected to at least one player terminal (FIG. 4); a server or a computer offering a virtual roulette game, allowing a player to play the roulette game. The physical roulette device may be an electronic portable or movable device, usually having at least one player station.

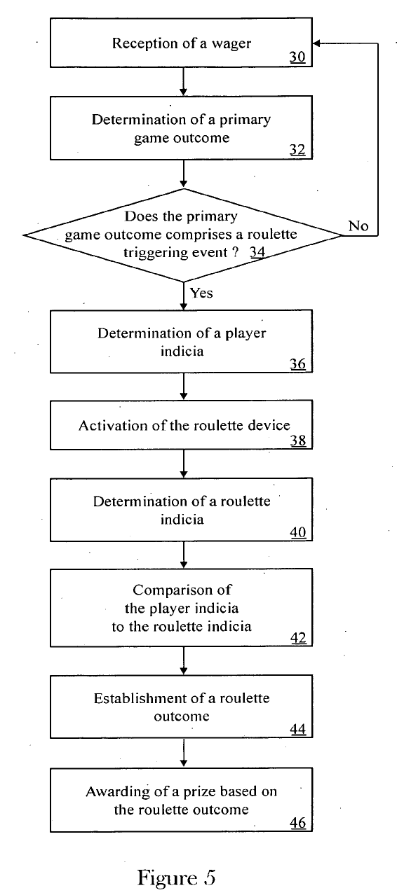

In a first embodiment, the roulette device is used on a stand-alone gaming apparatus 10 and comprises a second screen 12 installed on top of the actual gaming apparatus, as illustrated on FIG. 1. This device is a roulette-like mechanical or video wheel display 14. The game process for a game applying this embodiment is illustrated on FIG. 5. After a player has placed a wager (step 30), a primary game outcome is determined (step 32). If said primary game outcome comprises a roulette triggering event (step 34), the determination of a player indicia (step 36) is realized randomly, by using the primary game outcome as a determination means or by inviting the player to select a number, a combination of numbers (by selecting the intersection of a plurality of numbered squares), a color (red or black) or a characteristic (odd, even, “1 to 12”, “13 to 24”, “25 to 36”, etc.). The roulette device is activated (step 38). When the roulette device stops, a randomly selected roulette indicia (comprising a number, its associated color and characteristics) is determined (step 40). The roulette indicia (number, color and characteristics) is compared to the player indicia (step 42) to establish an outcome (step 44) and a prize is awarded according to a pay table (step 46).

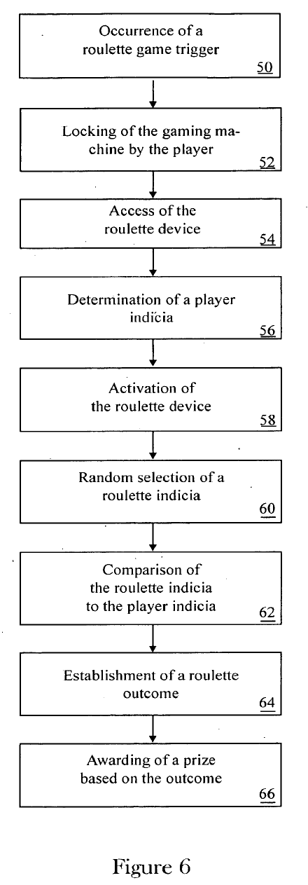

Another embodiment comprises a separate roulette device as illustrated on FIG. 3. It comprises a roulette wheel 27 and player selection means 28, which may be a touch screen, a keyboard or any other selection means. The roulette device is communicatively linked to at least one gaming machine (not shown). In this embodiment, the player leaves his gaming apparatus to follow the roulette game play on this separate device. The steps of this embodiment are described in FIG. 6. Upon occurrence of a roulette game trigger (step 50), the player locks his gaming machine (step 52), using a Personal Identification Number (PIN) or any other locking means, and physically accesses the roulette device (step 54). If the roulette device is available, using his PIN or another unlocking means, the player accesses a player selection means and selects an indicia (step 56). The roulette device is activated 58 and a roulette indicia is randomly selected (step 60). The roulette indicia is compared to the player indicia (step 62), establishing a roulette outcome (step 64), and a prize is awarded (step 66), according to said roulette outcome and a pay table.

The roulette device illustrated on FIG. 4 comprises not only the roulette wheel 27 but also player terminals 29, which are used as gaming machines to play both the primary game and the roulette game. In this embodiment, the player does not have to leave his gaming machine to play the roulette game, and also has the advantage of following the roulette game on a physical roulette device.

In another embodiment, the roulette game play is delayed until a condition is met (such as the occurrence of a roulette activation triggering event in the primary game) or when the player desires to play the roulette game. In this embodiment, upon occurrence of a roulette game trigger, the player is awarded a roulette game access permission, or “ticket”. Examples of the condition triggering the actual access to the roulette game are, not exclusively: a predetermined number of “tickets” have been gathered; the roulette device becomes available; the credit meter reaches a value of zero (0) credit or the player cashes out; a roulette activation triggering event occurs in the primary game; or a predetermined or randomly determined length of time since the last roulette game play elapses. The player indicia determination is done one indicia at a time, upon occurrence of a roulette game trigger, or all at the same time, upon roulette game play. During roulette game play, the roulette indicia is compared to all the player indicia and a prize is awarded based on the result of the comparison.

The roulette game may also be shared by a plurality of gaming machines, the roulette device being played by a player at a time or shared by a plurality of players in a competitive or a collaborative embodiment. In a competitive embodiment, the roulette indicia is compared to each player indicia independently and each player receives a prize based on their own performance in the game while in a collaborative embodiment, even though the roulette indicia is compared individually to each player indicia, all the players receive a prize if one of the player indicia matches the roulette indicia. In this embodiment, the prize for matching may be equally divided among the participating players; divided according to the number of “tickets” each player had in play in the roulette game; or most of the prize may be awarded to the player to whom the winning player indicia belonged, the rest of the prize being divided among the other players.

Another competitive embodiment may be a game wherein all the roulette numbers are distributed before the roulette game may be played. In this embodiment, the players choose a number each time a roulette triggering event occurs or a number is attributed to a player upon a win in the primary game, this attributed number being determined by the winning outcome (for example the roulette indicia if the primary game is a roulette game). Upon distribution of all roulette numbers to the participating players, the roulette device is activated and roulette indicia is determined. The player to whom the winning number belongs is awarded a prize.

The methods used to evaluate and award a prize may also vary. A first embodiment comprises a method of awarding a prize according to standard roulette evaluation: a player selects (or is attributed) a number, a combination of numbers (by selecting the intersection of a plurality of number squares), a color, or a characteristic (odd or even, “1 to 12”, “13 to 24”, “25 to 36”) and is awarded a prize according to a pay table if the roulette number and its characteristics match the player selection (or attribution).

A second prize awarding embodiment depends on the characteristics shared by the player indicia and the roulette indicia. Accordingly, closer are both indicia, more important is the prize. The characteristics considered to determine the prize are: red/black, odd/even, tiers (“1-12”, “13-24”, “25-36”). For example, the player selects the number “2”, which is black. The roulette indicia is “35”, which is also black. The player is awarded the prize corresponding to “1 characteristic” in the pay table since both indicia only share the color as common characteristic. On the other hand, if the roulette indicia is “4”, the player is awarded the prize corresponding to “3 characteristics” since both indicia are black, even and in the first tier.

Other prize determination embodiments, offered with single player embodiments, imply that more than one roulette indicia is determined and compared to the player indicia. The comparison may ask for a total match (same number) or a partial match (at least one common characteristic) to be determined as a winning match. A first of such embodiments offers increasing payout amounts, as long as the player indicia match the roulette indicia. Accordingly, upon a match with a first roulette indicia, a second roulette indicia is determined and compared to the player indicia. If this second roulette indicia also matches the player indicia, a higher payout amount is awarded to the player and so on until a roulette indicia doesn't match or a predetermined number of roulette indicia determination has been used up. Another embodiment offers decreasing payout amounts. Accordingly, if the player indicia doesn't match a first roulette indicia, a second roulette indicia is determined and compared to the player indicia. If the player indicia matches the roulette indicia, a prize, having a lower value than the prize awarded for a match with the first roulette indicia, is awarded. If not, a third roulette indicia is determined, and so on until a match or a predetermined number of roulette indicia determination has been used up.

The prize determination embodiments may also be used in conjunction with each other to construct a payout schedule offering a prize in all roulette game plays. For example, a total match (same number) may result in a second roulette indicia determination to award a higher prize to the player, while a totally unsuccessful match (no common characteristic) may offer a second roulette indicia to compare with a decreased payout amount.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium, processor-readable memory or an electrical or electromagnetic signal.

The embodiments of the invention described above are intended to be exemplary only. The scope of the invention is therefore intended to be limited solely by the scope of the appended claims.

1. A method of playing a roulette game device played in response to a trigger in a primary game provided on at least two gaming machines communicatively linked to, but physically distinct from, said roulette game device, said method comprising:
providing a player with a roulette game triggering event in said primary game played on said gaming machine;
the player locking said gaming machine;
said player accessing said roulette game device to play a roulette game;
receiving a player selection of player indicia from said player on said roulette game device;
activating said roulette game device;
randomly determining roulette indicia on said roulette game device; and
comparing said player indicia to said roulette indicia to determine a roulette game outcome for said player.

2. The method of claim 1, wherein the step of providing a player with a roulette game triggering event comprises gathering a roulette game access permission.

3. The method of claim 2, wherein the step of activating said roulette game device comprises allowing players having a roulette game access permission to participate in said roulette game together.

4. The method of claim 2, wherein said step of gathering a roulette game access permission comprises archiving said game access permission, and said step of receiving a player selection comprises receiving said player selection for each one of said archived game access permissions.

5. The method of claim 1 wherein said player indicia comprise one of a) a number; b) a combination of numbers; c) a color; or d) a characteristic; and said roulette indicia comprises a number and its associated color and characteristics.

6. The method of claim 1, wherein the step of comparing comprises awarding a prize according to game rules.

7. The method of claim 5, wherein the step of awarding a prize comprises awarding a participation prize to all players participating in a winning roulette game.
